(19) United States
(12) Patent Application Publication
(10) Pub. No.: US 2026/0319245 A1
(43) Pub. Date: Oct. 15, 2026

(54) OPTICALLY CORRECT CAMERA SHIELD

(71) Applicant: Tesla, Inc., Austin, TX (US)

(72) Inventor: Christos Gougoussis, Fremont, CA (US)

(21) Appl. No.: 19/501,323

(22) PCT Filed: Jul. 18, 2024
(86) PCT No.: PCT/US2024/038492

§ 371 Date: Jan. 12, 2026

Related U.S. Application Data
(60) Provisional application No. 63/514,303, filed on Jul. 18, 2023.

(51) Int. Cl. G02B 27/00

(52) U.S. Cl. CPC G02B 27/0012

(57) ABSTRACT

A camera shield that is optically corrected for placement in front of a camera is disclosed. When a curved shield with a uniform thickness is placed in front of a camera, the shield can create optical distortions. Optical corrections can be implemented onto the shield by adding a certain amount of vergence to a specific area of the shield. An amount of vergence can be added by changing an inner curvature radius of the shield such that the thickness of the shield is not uniform.

### CLAIM FOR PRIORITY

This application claims the benefit of priority of U.S. Provisional Application Ser. No. 63/514,303, filed Jul. 18, 2023, which is hereby incorporated by reference in its entirety.

### TECHNICAL FIELD

The present application relates to a camera shield that is optically corrected, or at least reduces optical distortion, in some examples.

### BACKGROUND

A camera shield can be desirable to be included in a camera system. For example, when a camera is implemented in a robot, a camera shield or face shield can protect the camera or for aesthetic or protective reasons. Such a camera shield may be curved and is usually of a uniform thickness throughout the entire field of view of the camera. However, the camera shield can cause optical distortion. Therefore, it may be advantageous to provide a cameral shield that does not introduce optical corrections to improve the camera system's image quality.

### SUMMARY

Some examples herein relate to a camera shield that in some cases can provide a protective and corrective cover placed in front of a camera lens. Unlike typical camera shields that have a uniform thickness and can distort images, example camera shields herein are designed with different zones, each zone having its own unique curvature. These curvatures are calculated to correct optical distortions like blurring, ensuring that the camera captures clearer and more accurate images.

By adjusting the way light enters the camera through different parts of the shield, some examples seek to ensure that images are clearer and more precise, regardless of the distance of the object from the camera. This may be particularly beneficial in environments where precision is important, such as in surveillance, high-quality photography, or autonomous vehicle driving systems.

Example shields herein can be adapted to fit various types of cameras and lens sizes, making them versatile for different camera needs and/or environments.

In addition to improving image quality, some examples camera shields also protects the camera lens from environmental elements like dust and moisture, which may damage the lens over time.

Some examples support environmental sustainability by enabling recycling at the end of a lifecycle, reducing waste. Example camera shields may include features like a snap-fit mechanism, enabling ease of installation and removal, offering convenience to the user.

In some example camera systems, a camera shield is be integrated with sensors that allow the camera system to automatically adjust camera settings based on the object's distance, enhancing the camera's functionality and user experience.

Some examples herein may relate to an optically corrected camera shield. Some examples are also referred to herein and in the priority application as an “optically correct” camera shield. These terms are used synonymously where the context permits. The term “optically correct” is not intended to denote that an example camera shield is optically “perfect” as it were, but rather that a feature or improvement has been made to a camera shield to improve optical performance, or reduce optical defects or impairments of a conventional camera shield, in some examples.

One aspect is directed to an optically corrected camera shield, the camera shield comprising an upper portion, a middle portion, and a lower portion. The upper portion configured to have a first focus distance, the upper portion having a first inner curvature radius and a first outer curvature radius. The middle portion configured to have a second focus distance, the middle portion having a second inner curvature radius and a second outer curvature radius. The lower portion configured to have a third focus distance, the lower portion having a third inner curvature radius and a third outer curvature radius. The first inner curvature radius is determined based on at least the first focus distance, the second inner curvature radius is determined based on at least the second focus distance, and the third inner curvature radius is determined based on at least the third focus distance.

A variation of the aspect above is, wherein the first outer curvature radius, the second outer curvature radius, and the third outer curvature radius are the same.

Another aspect of this disclosure includes a method for manufacturing an optically correct camera shield. The method comprises determining a first focus distance in an upper field of view of the camera shield, wherein the upper field of view of the camera shield has a first inner curvature radius and a first outer curvature radius. The method further comprises determining a second focus distance in a middle field of view of the camera shield, wherein the middle field of view of the camera shield has a second inner curvature radius and a second outer curvature radius. The method also comprises determining a third focus distance in a lower field of view of the camera shield, wherein the lower field of view of the camera shield has a third inner curvature radius and a third outer curvature radius. The method also comprises forming the camera shield to have a) the first inner curvature radius based at least on the first focus distance, b) the second inner curvature radius based at least on the second focus distance, and c) the third inner curvature radius based at least on the third focus distance.

Another aspect of this disclosure includes a camera shield having a generally curved shape for placement in a field of view of a camera. The camera shield comprises a body having an optical correction disposed in the field of view of the camera and being sized and shaped to adjust a vergence of light traveling through the camera shield so as to reduce image blurring and form an image within a focus range of the camera.

A variation of the aspect above is, wherein the body comprises an outer radius of curvature R₁ and an inner radius of curvature R₂, and wherein R₁<R₂.

A variation of the aspect above is, wherein

$${R}_{1} - t + \frac{1}{2 n} < {R}_{2} ,$$

wherein the body has a refractive index of n, and wherein a thickness t of the body is R₁−R₂.

A variation of the aspect above is, wherein

$${R}_{2} < {R}_{1} - t + \frac{100 t}{n} .$$

The camera shield of Claim 7, wherein R₂ is:

$$- \frac{d ( n - 1 ) ( {R}_{1} n - n t + t )}{n ( {R}_{1} - dn + d )} ,$$

and wherein d is a distance from the outer radius of curvature R₁ of the camera shield to an object in the field of view of the camera.

### BRIEF DESCRIPTION OF THE DRAWINGS

The present disclosure is described with reference to the accompanying drawings, in which like reference characters reference like elements, and wherein:

FIG. 1A illustrates a cameral shield that has a uniform thickness located in the field of view of a camera.

FIG. 1B illustrates a camera shield according to an example example of the present disclosure.

FIG. 2 is a diagram showing example nominal distortion caused by the camera shield of FIG. 1A.

FIG. 3 illustrates two different angles in the field of view of the camera through the camera shield of FIG. 1B.

### DETAILED DESCRIPTION

Generally described, one or more aspects of the present disclosure relate to an optically correct (or optically corrected) camera shield. In some examples, methods and systems disclosed herein relates to molded optically correct camera shieled for use with a camera. In some examples, the cameral shield can improve the image quality of the camera by changing vergence of light traveling through the shield. In some examples, the camera shield can be implemented to add or subtract a different amount of vergence to different areas of the camera shield.

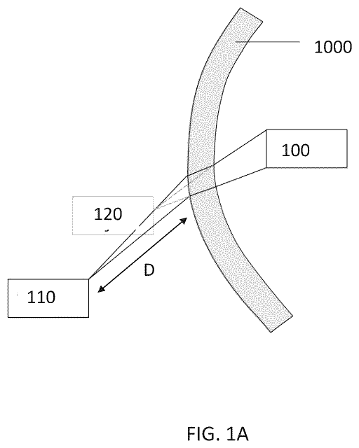

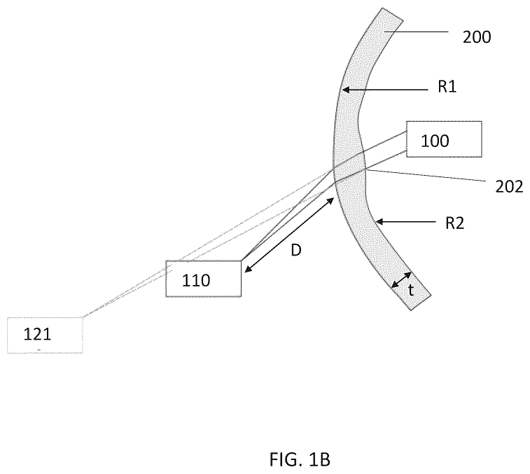

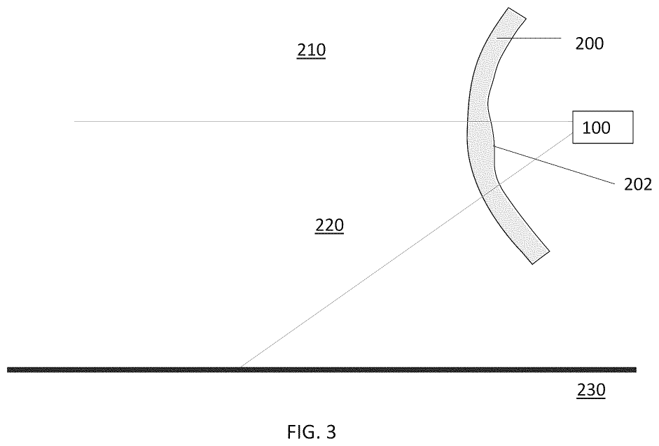

FIG. 1A shows a camera system with a curved shield 1000 of a uniform thickness placed in front of a camera 100. An object 110, when sensed by the camera 100 through the uniform shield 1000, will appear to be closer to the camera 100 and in the position of a virtual object 120. The curved shield 1000 can create a negative vergence and induce image blurring. FIG. 3 shows distortion that may occur in the camera 100 image with the shield 1000, reaching values up to −250 milli-diopters (mdpt). The distortion value indicates the amount of optical corrections needed in the shield. In some examples, the distortion value can be up to 2000 mdpt or more, depending on the shape of the shield.

FIG. 1B illustrates a camera shield 200 according to an example example of the present disclosure. In certain examples, the camera shield 200 includes an optical correction 202. The shape or profile of the optical correction 202 can be molded as part of the camera shield 200, in some examples. In some examples, the optical correction 202 (or a shape and/or profile) can be added to an already formed camera shield. In certain examples, the optical correction 202 is separately manufactured and assembled to the camera shield 200.

The camera shield 200 can be disposed in front of or in the field of view of the camera 100. In certain examples, a portion of the camera shield 200 includes the optical correction 202. In certain examples, the portion of the camera shield 200 is in the field of view of the camera 100. In certain examples, the optical correction 202 can tune vergence of light traveling through the local area to reduce image blurring and form an image within the optimal focus range of the camera 100. For example, as shown in FIG. 1B, the same object 110 in FIG. 1A can be placed at a same distance D from the camera shield 200. Due to the optical correction 202, the object 110 may appear in the position of a virtual object 121 that is further away than the actual object 110. In certain examples, the camera shield 200 includes more than one optical correction 202 or optical correction 202 region.

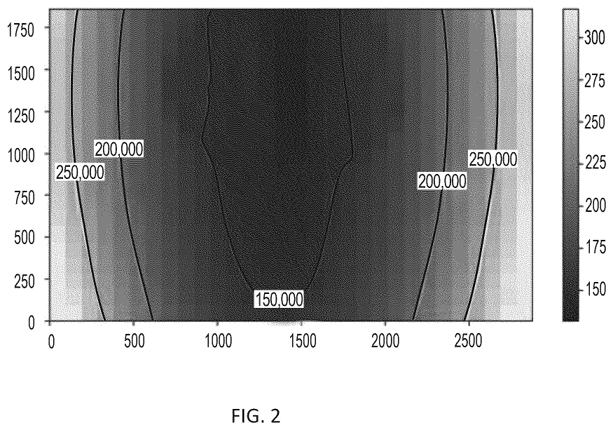

In some examples, the optical correction 202 can be implemented to vary the amounts of vergence for objects positioned at different locations relative to the camera 100. For example, objects appearing in zone 210, which is at or above the same horizontal plane as the camera 100, are usually further away from the camera shield 200 and the camera 100 and require a longer focus distance. Objects appearing in zone 220, which is below or at ground level 230, are usually closer to the camera shield 200 and the camera 100 and require a shorter focus distance (see FIG. 2). Accordingly, in some examples, the optical correction, e.g., vergence, can be implemented in different areas of the shield 200 such that a lower vergence is added for objects in zone 210, and higher vergence is added for objects in zone 220.

In some examples, the optical correction 202 can be implemented by varying an inner curvature radius R2 of the shield 200 (see FIG. 1B). In some examples, the optical correction 202 can be implemented by molding selective areas of a sheet made of a transparent material having a certain refractive index n. In some examples, the optical correction 202 can be formed by using an outer mold and an inner mold, which have surfaces that are not parallel with each other when the transparent material is injected or pressed. In some examples, the transparent material can be any material with a desirable refractive index, for example, including but not limited to poly methyl methacrylate (PMMA), polycarbonate, glass, or one of such materials tinted to have a transmission rate between 5 and 100%, and/or having a coating on an inner or the outer surface of the material or camera shield. In some examples, a material used for making an example camera shield 200 can have a refractive index n in a range of, for example, 1-4, 1.1-3.5, 1.3-3, and 1.4-1.7. Other ranges of refractive index are possible. In some examples, an example camera shield 200 having an optical correction 202 can have a thickness t in a range of, for example, 0.5-2 mm, 0.3-3 mm, and 0.8-1.5 mm. Other ranges of thickness are possible.

As illustrated in FIG. 1B, the camera shield 200 can have an outer curvature radius R1 and the inner curvature radius R2. In some examples, the outer curvature and the inner curvature may not share the same center. In some examples, a value of the inner curvature radius R2 can be determined based on an estimated distance of common objects that may appear in front of the shield 200 within a zone, e.g., the zone 220, and/or one or more properties of the shield 200 (e.g., the refractive index n of the shield 200, the thickness t of the shield 200). In some examples, a range of value for the inner curvature radius R2 can be determined using the equations:

$$R 1 - t + \frac{1}{2 n} < R 2$$

$$R 2 < R 1 - t + \frac{100 t}{n}$$

In some examples, an example value for the inner curvature radius R2 can be determined using the formula, with d being a target distance between an object and the shield 200:

$$R 2 = - \frac{d ( n - 1 ) ( R 1 n - n t + t )}{n ( R 1 - d n + d )}$$

### EXAMPLES

Some examples herein may include one or more of the following aspects.

Example 1 includes an optically correct camera shield, the camera shield comprising: an upper portion configured to have a first focus distance, the upper portion having a first inner curvature radius and a first outer curvature radius; a middle portion configured to have a second focus distance, the middle portion having a second inner curvature radius and a second outer curvature radius; and a lower portion configured to have a third focus distance, the lower portion having a third inner curvature radius and a third outer curvature radius; wherein the first inner curvature radius is determined based on at least the first focus distance, the second inner curvature radius is determined based on at least the second focus distance, and the third inner curvature radius is determined based on at least the third focus distance.

Example 2 includes the camera shield of Example 1, wherein the first outer curvature radius, the second outer curvature radius, and the third outer curvature radius are the same.

Example 3 includes a method for manufacturing an optically correct camera shield, the method comprising: determining a first focus distance in an upper field of view of the camera shield, wherein the upper field of view of the camera shield has a first inner curvature radius and a first outer curvature radius; determining a second focus distance in a middle field of view of the camera shield, wherein the middle field of view of the camera shield has a second inner curvature radius and a second outer curvature radius; determining a third focus distance in a lower field of view of the camera shield, wherein the lower field of view of the camera shield has a third inner curvature radius and a third outer curvature radius; and forming the camera shield to have a) the first inner curvature radius based at least on the first focus distance, b) the second inner curvature radius based at least on the second focus distance, and c) the third inner curvature radius based at least on the third focus distance.

Example 4 includes a camera shield having a generally curved shape for placement in a field of view of a camera, the camera shield comprising: a body having an optical correction disposed in the field of view of the camera and being sized and shaped to adjust a vergence of light traveling through the camera shield so as to reduce image blurring and form an image within a focus range of the camera.

Example 5 includes the camera shield of Example 4, wherein the body comprises an outer radius of curvature R1 and an inner radius of curvature R2, and wherein R1<R2.

Example 6 includes the camera shield of Example 4 or Example 5, wherein

$${R}_{1} - t + \frac{1}{2 n} < {R}_{2} ,$$

wherein the body has a refractive index of n, and wherein a thickness t of the body is R₁−R₂.

Example 7 includes the camera shield of any one of Examples 4-6, wherein

$${R}_{2} < {R}_{1} - t + \frac{100 t}{n} .$$

Example 8 includes the camera shield of any one of Examples 4-7, wherein R₂ is:

$$- \frac{d ( n - 1 ) ( {R}_{1} n - n t + t )}{n ( {R}_{1} - dn + d )} ,$$

and wherein d is a distance from the outer radius of curvature R1 of the camera shield to an object in the field of view of the camera.

In some examples, a material of the camera shield includes a material selected from a group of materials comprising poly methyl methacrylate (PMMA), polycarbonate, glass, and combinations thereof, each optionally tinted or coated to adjust light transmission rates. In some examples, the camera shield material has a light transmission rate between 5% and 100%.

In some examples, an optical correction is formed by a molding process using an outer mold and an inner mold having non-parallel surfaces. In some examples, an optical correction is formed in the camera shield by integrating the molded optical correction into the body of the camera shield during the manufacturing process.

In some examples, an optical correction is configured to adjust a vergence of light for objects located at varying distances from the camera, thereby optimizing the focus for objects in both near and far fields of view. In some examples, the vergence adjustment is achieved by varying the inner curvature radius in different zones of the camera shield, each zone corresponding to a typical distance range of objects from the camera. In some examples, the zones include an upper zone configured for distant objects and a lower zone configured for closer objects, with each zone having a different inner curvature radius optimized for its respective distance range. In some examples, an inner curvature radius for each zone is calculated based on the refractive index of the shield material and the typical distance of objects in that zone, using a formula provided in the detailed description above.

In some examples, a camera shield comprises multiple zones, each zone having a distinct optical correction configured to adjust the vergence of light based on the distance of objects within the zone.

In some examples, each zone's optical correction is defined by a inner curvature radius that varies across the shield to optimize image clarity.

In some examples, the inner curvature radius for each zone is calculated using a formula that incorporates the refractive index of the shield material and the expected range of object distances in each zone.

In some examples, a material of the shield is selected to minimize optical aberrations and enhance light transmission. In some examples, the material includes an anti-reflective coating to reduce glare and improve visibility.

In some examples, the camera shield includes a gradient of thickness across its surface to further tailor optical properties and correct for spherical aberrations. In some examples, the gradient in thickness is achieved through a precision molding process that varies the shield's cross-sectional profile.

In some examples, a method for manufacturing a camera shield is provided. An example method comprises the steps of designing zones with predetermined focus distances and corresponding curvature radii to create a zone-specific vergence adjustment.

In some examples, the curvature radii are determined based on a computational model that simulates optical performance across varying distances and object placements.

Some examples further comprise the step of applying a coating to the shield to enhance optical performance and durability.

In some examples, a camera system incorporates a camera shield as summarized above, wherein the camera system is configured to automatically adjust focus based on the detected position of objects relative to the shield's zones.

In some examples, the camera system includes sensors to detect object distance and provide feedback to adjust camera settings in real-time.

In some examples, the camera shield is adaptable to different camera types and sizes through customizable mounting mechanisms. In some examples, a mounting mechanism includes a snap-fit feature allowing for quick installation and removal.

Some example camera shields further comprise a peripheral seal to prevent ingress of dust and moisture into a camera to which the shield is fitted. In some examples, the seal is made from a flexible, weather-resistant material that conforms to the camera's contour.

In some examples, a camera shield is further configured to adjust chromatic aberration through selective material composition and structural design.

In some examples, the camera shield includes embedded sensors to monitor its optical performance and signal when maintenance or replacement is needed. In some examples, the sensors are integrated into the shield without affecting its optical correction capabilities.

The foregoing disclosure is not intended to limit the present disclosure to the precise forms or particular fields of use disclosed. As such, it is contemplated that various alternate examples and/or modifications to the present disclosure, whether explicitly described or implied herein, are possible in light of the disclosure. Having thus described examples of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific examples. However, as one skilled in the art will appreciate, various examples disclosed herein can be modified or otherwise implemented in various other ways without departing from the spirit and scope of the disclosure. Accordingly, this description is to be considered as illustrative and is for the purpose of teaching those skilled in the art the manner of making and using various examples of the disclosed optical corrections in camera shield. It is to be understood that the forms of disclosure herein shown and described are to be taken as representative examples. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including,” “comprising,” “incorporating,” “consisting of,” “have,” “is” used to describe and claim the present disclosure are intended to be construed in a non-exclusive manner, namely allowing for items, components or elements not explicitly described also to be present. Reference to the singular is also to be construed to relate to the plural.

Further, various examples disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first,” “second,” “third,” “primary,” “secondary,” “main” or any other ordinary and/or numerical terms, should also be taken only as identifiers, to assist the reader's understanding of the various elements, examples, variations and/or modifications of the present disclosure, and may not create any limitations, particularly as to the order, or preference, of any element, example, variation and/or modification relative to, or over, another element, example, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. An optically correct camera shield, the camera shield comprising:
an upper portion configured to have a first focus distance, the upper portion having a first inner curvature radius and a first outer curvature radius;
a middle portion configured to have a second focus distance, the middle portion having a second inner curvature radius and a second outer curvature radius; and
a lower portion configured to have a third focus distance, the lower portion having a third inner curvature radius and a third outer curvature radius;
wherein the first inner curvature radius is determined based on at least the first focus distance, the second inner curvature radius is determined based on at least the second focus distance, and the third inner curvature radius is determined based on at least the third focus distance.

2. The camera shield of claim 1, wherein the first outer curvature radius, the second outer curvature radius, and the third outer curvature radius are the same.

3. A method for manufacturing an optically correct camera shield, the method comprising:
determining a first focus distance in an upper field of view of the camera shield, wherein the upper field of view of the camera shield has a first inner curvature radius and a first outer curvature radius;
determining a second focus distance in a middle field of view of the camera shield, wherein the middle field of view of the camera shield has a second inner curvature radius and a second outer curvature radius;
determining a third focus distance in a lower field of view of the camera shield, wherein the lower field of view of the camera shield has a third inner curvature radius and a third outer curvature radius; and
forming the camera shield to have a) the first inner curvature radius based at least on the first focus distance, b) the second inner curvature radius based at least on the second focus distance, and c) the third inner curvature radius based at least on the third focus distance.

4. A camera shield having a generally curved shape for placement in a field of view of a camera, the camera shield comprising:
a body having an optical correction disposed in the field of view of the camera and being sized and shaped to adjust a vergence of light traveling through the camera shield so as to reduce image blurring and form an image within a focus range of the camera.

5. The camera shield of claim 4, wherein the body comprises an outer radius of curvature R₁ and an inner radius of curvature R₂, and wherein R₁<R₂.

6. The camera shield of claim 5, wherein
$${R}_{1} - t + \frac{1}{2 n} < {R}_{2} ,$$
wherein the body has a refractive index of n, and wherein a thickness t of the body is R₁−R₂.

7. The camera shield of claim 6, wherein
$${R}_{2} < {R}_{1} - t + \frac{100 t}{n} .$$

8. The camera shield of claim 7, wherein R₂ is:
$$- \frac{d ( n - 1 ) ( {R}_{1} n - n t + t )}{n ( {R}_{1} - dn + d )} ,$$
and wherein d is a distance from the outer radius of curvature R₁ of the camera shield to an object in the field of view of the camera.

9. The camera shield of claim 8, wherein the body's material is selected from a group comprising poly methyl methacrylate (PMMA), polycarbonate, glass, and combinations thereof, each optionally tinted or coated to adjust light transmission rates.

10. The camera shield of claim 9, wherein the material has a light transmission rate between 5% and 100%.

11. The camera shield of claim 4, wherein the optical correction is formed by a molding process using an outer mold and an inner mold having non-parallel surfaces.

12. The camera shield of claim 11, wherein the optical correction is formed in the camera shield by integrating the molded optical correction into the body of the camera shield during the manufacturing process.

13. The camera shield of claim 4, wherein the optical correction is configured to adjust a vergence of light for objects located at varying distances from the camera, thereby optimizing the focus for objects in both near and far fields of view.

14. The camera shield of claim 13, wherein the vergence adjustment is achieved by varying the inner curvature radius in different zones of the camera shield, each zone corresponding to a typical distance range of objects from the camera.

15. The camera shield of claim 14, wherein the zones include an upper zone configured for distant objects and a lower zone configured for closer objects, with each zone having a different inner curvature radius optimized for its respective distance range.
